(19) United States
(12) Patent Application Publication
(10) Pub. No.: US 2026/0142374 A1
(43) Pub. Date: May 21, 2026

(54) WIDE BEAM ULTRA-WIDEBAND ANTENNA

(71) Applicant: TE Connectivity Solutions GmbH, Schaffhausen (CH)

(72) Inventors: Rizwan KHAN, Prai (MY); Wai Hau NG, Prai (MY); KokJiunn NG, Prai (MY)

(21) Appl. No.: 19/392,385

(22) Filed: Nov. 18, 2025

(30) Foreign Application Priority Data
Nov. 21, 2024 (MY) 2024006666

(51) Int. Cl. H01Q 5/25; H01Q 5/35; H01Q 5/378

(52) U.S. Cl. CPC H01Q 5/25; H01Q 5/35; H01Q 5/378

(57) ABSTRACT

An ultra-wideband (UWB) antenna includes a substrate having a first surface and a second surface. The UWB antenna includes a radiating patch at the first surface. The UWB antenna includes parasitic elements at the first surface adjacent the radiating patch and an antenna ground at the second surface. The UWB antenna includes shorting pins between the radiating patch and the antenna ground. The UWB antenna has a wide beam angle greater than 120°. The UWB antenna covers the UWB channel 9 and/or channel 10 frequency band(s).

### CROSS REFERENCE TO RELATED APPLICATIONS

This application claims the benefit of Malaysia Application No. 2024006666, filed 21 Nov. 2024, the subject matter of which is herein incorporated by reference in its entirety.

### BACKGROUND OF THE INVENTION

The subject matter herein relates generally to antennas.

Ultra-wideband (UWB) technology is known wireless technology having wireless standards like Wi-Fi, Bluetooth & GNSS. UWB technology leverages radio signals to communicate and transfer data between different devices. UWB technology includes a broad spectrum of frequencies higher than Wi-Fi and Bluetooth frequencies having wide bandwidth in GHz frequency range. UWB technology uses low power consumption and has high positional accuracy. UWB can be used to find the direction and precise location of a device, such as to within a few centimeters. Due to such high accuracy, UWB is used for locating and communicating with devices quickly and accurately. However, due to high frequency the penetration depth is small so for UWB to work properly, a clear line of sight is necessary.

Conventional devices incorporating UWB antennas utilize magneto-electric dipole to enhance beamwidth, which is a complex way of achieving good UWB characteristics. Conventional UWB antennas are highly dependent on the ground plane. Conventional UWB antennas utilize a microstrip patch antenna which has a major disadvantage of small impedance bandwidth and narrow beamwidth, thus, are applied with limitations in the communication system. Other conventional UWB antennas use stacked microstrip antennas which have high complexity to optimize the radiation characteristics.

A need remains for an improved UWB antenna.

### BRIEF DESCRIPTION OF THE INVENTION

In one embodiment, an ultra-wideband (UWB) antenna is provided and includes a substrate having a first surface and a second surface. The UWB antenna includes a radiating patch at the first surface. The UWB antenna includes parasitic elements at the first surface adjacent the radiating patch and an antenna ground at the second surface. The UWB antenna includes shorting pins between the radiating patch and the antenna ground. The UWB antenna has a wide beam angle greater than 120°. The UWB antenna covers the UWB channel 9 frequency band.

In another embodiment, an ultra-wideband (UWB) antenna assembly is provided and includes a host circuit board. The UWB antenna includes a first UWB antenna mounted to the host circuit board. The first UWB antenna includes a first substrate having a first surface and a second surface, a first radiating patch at the first surface of the first substrate, first parasitic elements at the first surface of the first substrate adjacent the first radiating patch, a first antenna ground at the second surface of the first substrate, and first shorting pins between the radiating patch and the antenna ground. The first UWB antenna has a wide beam angle greater than 120° and the first UWB antenna covers the UWB channel 9 frequency band. The UWB antenna includes a second UWB antenna mounted to the host circuit board. The second UWB antenna includes a second substrate having a first surface and a second surface, a second radiating patch at the first surface of the second substrate, second parasitic elements at the first surface of the second substrate adjacent the second radiating patch, a second antenna ground at the second surface of the second substrate, and second shorting pins between the radiating patch and the antenna ground. The second UWB antenna has a wide beam angle greater than 120° and the second UWB antenna covers the UWB channel 9 frequency band.

### BRIEF DESCRIPTION OF THE DRAWINGS

FIG. 1 is a UWB antenna assembly in accordance with an exemplary embodiment.

FIG. 2 is a perspective view of a portion of the UWB antenna assembly in accordance with an exemplary embodiment.

FIG. 3 is an exploded view of the UWB antenna in accordance with an exemplary embodiment.

FIG. 4 is a top view of the UWB 100 in accordance with an exemplary embodiment.

FIG. 5 is a bottom view of the UWB antenna in accordance with an exemplary embodiment.

FIG. 6 is a top view of the UWB antenna in accordance with an exemplary embodiment.

FIG. 7 is a top view of the UWB antenna in accordance with an exemplary embodiment.

FIG. 8 is a top view of the UWB antenna in accordance with an exemplary embodiment.

FIG. 9 is a top view of the UWB antenna in accordance with an exemplary embodiment.

FIG. 10 illustrates the UWB antenna assembly showing the first and second UWB antennas in accordance with an exemplary embodiment mounted to the host circuit board.

FIG. 11 illustrates the UWB antenna assembly showing the first and second UWB antennas in accordance with an exemplary embodiment mounted to the host circuit board.

FIGS. 12-55 provide results for UWB antennas in accordance with exemplary embodiments.

### DETAILED DESCRIPTION OF THE INVENTION

Embodiments described herein provide a wide beam shorted patch UWB antenna with parasitic elements. The antenna is designed to have a wide beam (for example, greater than 120°) in the electric field (E-plane) and the magnetic field (H-plane). The antenna is designed with a well-directed radiation pattern across one or more frequency bands, such as for UWB channel 9 and/or UWB channel 10. In various embodiments, the antenna is designed to operate in a frequency range of 7.9872-8.4864 GHz and 8.4864 8.9856 GHz which is wideband in the application of UWB Channel 9 and 10, respectively. The antenna has a small footprint and low profile to fit into a compact antenna module.

In an embodiment, a simple shorted patch antenna is used to achieve a wide bandwidth. The antenna may have a thick PCB/substrate, such as having a thickness of approximately 3 mm. The antenna may have multiple shorting vias that are shorted to the ground plane. The shorted patch helps to reduce the overall size and helps to enhance the bandwidth. In various embodiments, a set of parasitic elements is implemented and optimized which enhances the radiation pattern of the radiating element. The shorted patch antenna has a radiation pattern that exhibits wide beam width (for example, greater than 120°) which eliminates blind spots or narrower field patterns of conventional antennas. The radiation pattern of the antenna is consistent across the wide range of the UWB channels 9 and 10, which ensures a stable magnitude of transfer function. Due to the constant radiation pattern, this UWB antenna has a consistent fidelity factor across the wide beamwidth.

Embodiments of the antenna design can be utilized as a surface mount antenna due to its simplicity and can be implemented in antenna modules where applicable. This antenna is scalable, and the size can be scaled to different operating frequencies based on the application requirements. The parasitic elements also can be enhanced further along with the patch size to improve the beamwidth of the overall antenna. The beamwidth of the radiation pattern in the E and H planes has consistent performance across a wide range of frequencies. Embodiments of the antenna are utilized in a linear-polarized UWB antenna system with a wideband frequency range of channel 9 and channel 10. The compact antenna geometry is achieved, which may be less than 4 mm tall, which allows the antenna to fit inside the compact housing of a UWB antenna module.

Embodiments of the antenna have the advantages of a relatively simple structure for SMT mount, wider resonance bandwidth in a radiation frequency band, stable directional radiation pattern, wide half-power beamwidth, as well as low cost. The antenna can realize >1 GHz bandwidth without increasing the size. The antenna is not just limited to a specific ground size it can be mounted on different sizes/shapes of the ground plane.

Today's vehicles require robust and reliable information about in-cabin occupancy. Smart airbag deployment systems, air condition controls, and the detection of children and disabled people left behind in vehicles rely upon this information. Due to the antenna performance such as a wide bandwidth and a wide beam width make the antenna design suitable to be used in UWB modules for secure and precise localization for a variety of applications like in cabin radar systems for the presence of any living organism (pet, human etc.), UWB Ranging, and the like. Moreover, it is also suitable for the unit to form an antenna array for base-station/phased array applications due to its steady structure and high scalability.

The antenna design is not limited to how many antennas are in a single package/module/device. Various embodiments include a 2×2 MIMO antenna structure with two ports, however the antenna can be implemented in multiple configurations based on the requirements of the application. The shorted patch with parasitic elements is also not limited to being designed using PCB, it is still operational when implemented on ceramic dielectric or laser-direct structuring with some optimization in the shape of a shorted patch. The antenna design is also not just limited to the linear polarization, the shorted patch can also be designed in a different way to achieve different polarization.

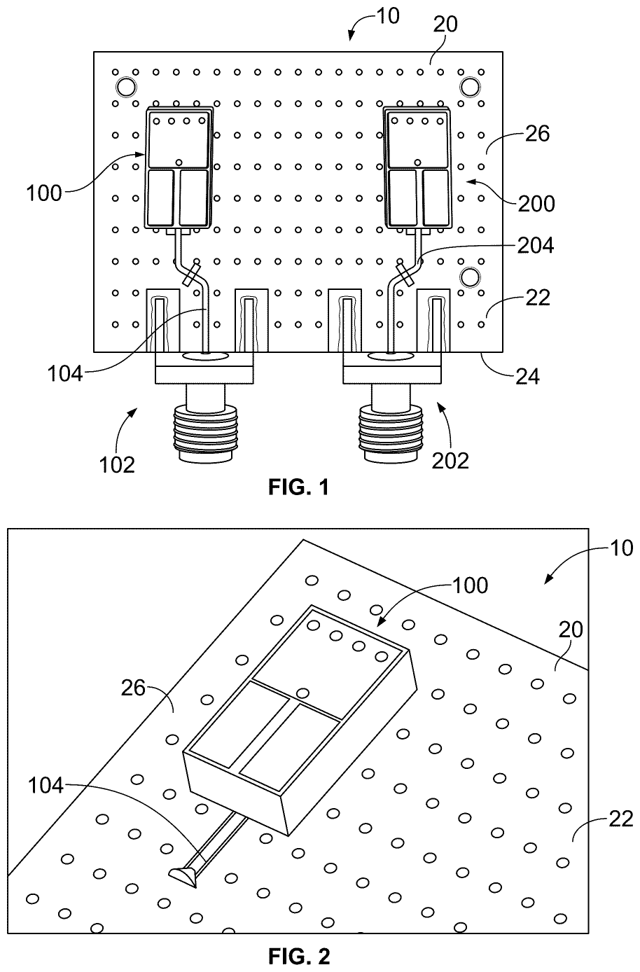

FIG. 1 is a UWB antenna assembly 10 in accordance with an exemplary embodiment. FIG. 2 is a perspective view of a portion of the UWB antenna assembly 10. The UWB antenna assembly 10 includes a host circuit board 20 and one or more UWB antennas mounted to the host circuit board 20. In an exemplary embodiment, the UWB antenna assembly 10 may include a housing or cover (not shown). For example, the host circuit board 20 and the UWB antennas may be received in the housing or cover.

In the illustrated embodiment, the UWB antenna assembly 10 includes a pair of UWB antennas, namely a first UWB antenna 100 (shown in FIG. 2) and a second UWB antenna 200. The UWB antenna assembly 10 may include greater or fewer UWB antennas in alternative embodiments. The UWB antennas 100, 200 may be identical to each other. Alternatively, the UWB antennas 100, 200 may be different from each other, such as different size and/or shape to cover different frequencies. In an exemplary embodiment, the UWB antennas 100, 200 are wide beam shorted patch UWB antennas with parasitic elements.

The UWB antenna assembly 10 includes one or more coaxial feed ports mounted to the host circuit board 20 and coupled to the corresponding UWB antennas. In the illustrated embodiment, the UWB antenna assembly 10 includes a pair of coaxial feed ports, namely a first coaxial feed port 102 and a second UWB antenna 200. The UWB antenna assembly 10 may include greater or fewer coaxial feed ports in alternative embodiments. The first coaxial feed port 102 is electrically coupled to the first UWB antenna 100 by a first feed line 104. The second coaxial feed port 202 is electrically coupled to the second UWB antenna 200 by a second feed line 204. The coaxial feed ports 102, 202 may be mounted to the host circuit board 20 at one or more edges of the host circuit board 20.

The host circuit board 20 includes one or more layers between a first or upper surface 22 and a second or lower surface 24. The host circuit board 20 includes a ground layer 26, such as at the upper surface 22. The UWB antennas 100, 200 are configured to be electrically coupled to the ground layer 26. For example, the UWB antennas 100, 200 may be surface mounted to the ground layer 26 at the upper surface 22. For example, the UWB antennas 100, 200 may be soldered to the ground layer 26 at the upper surface 22. The coaxial feed ports 102, 202 may be electrically coupled to the ground layer 26, such as being soldered to the ground layer 26 at the lower surface 24.

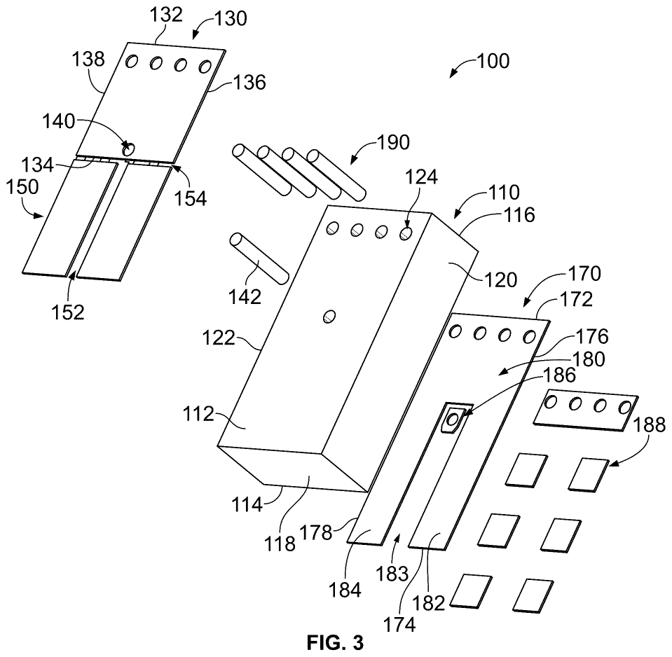

FIG. 3 is an exploded view of the UWB antenna 100 in accordance with an exemplary embodiment. The UWB antenna 100 includes a substrate 110, a radiating patch 130, parasitic elements 150 adjacent the radiating patch, an antenna ground 170, and shorting pins 190 between the radiating patch 130 and the antenna ground 170.

In an exemplary embodiment, the UWB antenna 100 is designed to have a wide beam angle greater than 120°. For example, the UWB antenna 100 has a wide beam angle greater than 120° in an electric field (E-plane) and the UWB antenna has a wide beam angle greater than 120° in a magnetic field (H-plane). In an exemplary embodiment, the UWB antenna 100 is designed to cover the UWB channel 9 frequency band. In an exemplary embodiment, the UWB antenna 100 is designed to cover the UWB channel 10 frequency band. In an exemplary embodiment, the UWB antenna 100 is operable at a frequency range of between 7987.2-8985.6 MHz. The UWB antenna 100 may be designed to cover other frequency bands in alternative embodiments. In an exemplary embodiment, the UWB antenna 100 has a fidelity factor of greater than 0.95. In an exemplary embodiment, the UWB antenna 100 has a VSWR less than 3:1. In various embodiments, the UWB antenna 100 has a VSWR less than 2:1. In an exemplary embodiment, the UWB antenna 100 has isolation of greater than 20 dB. In an exemplary embodiment, the UWB antenna 100 has an impedance of 50 Ohms. In an exemplary embodiment, the UWB antenna 100 has a total efficiency of greater than 70%. In an exemplary embodiment, the UWB antenna 100 has a front-to-back ratio of greater than 20 dB. In an exemplary embodiment, the UWB antenna 100 may have a height of less than 4 mm. In an exemplary embodiment, the UWB antenna 100 may have a 3-dB beamwidth (azimuth) of between 120°-160°. In an exemplary embodiment, the UWB antenna 100 may have a 3-dB beamwidth (elevation) of between 120°-160°. In an exemplary embodiment, the UWB antenna 100 may have a pulse delay of less than 0.20 ns. In various embodiments, the UWB antenna 100 may have a pulse delay of less than 0.17 ns.

The substrate 110 includes a first or upper surface 112 and a second or lower surface 114. The substrate 110 has a thickness defined between the first and second surfaces 112, 114. In an exemplary embodiment, the substrate 110 includes a first end 116 and a second end 118 opposite the first end 116. The substrate 110 has a length defined between the first and second ends 116, 118. The substrate 110 includes a first side 120 and the second side 122 opposite the first side 120. The first and second sides 120, 122 extend between the first and second ends 116, 118. The substrate 110 has a width defined between the first and second sides 120, 122. The sides and the ends may be perpendicular to each other. The substrate 110 may include additional edges in alternative embodiments.

In the illustrated embodiment, the substrate 110 is rectangular. However, the substrate 110 may have other shapes in alternative embodiments. The substrate 110 is sized to allow positioning of the UWB antenna 100 in a particular envelope, such as a particular antenna module housing size. While the substrate 110 generally has a low profile (to fit in the antenna module housing), the thickness of the substrate 110 is selected to have an important role in tuning the resonance frequency, such as to allow adequate spacing between the radiating patch 130 and the antenna ground 170. In an exemplary embodiment, the substrate 110 has a width-to-height ratio of approximately 2:1 and/or a width-to-length ratio of approximately 4:1. In an exemplary embodiment, the substrate 110 has a length-to-width ratio of approximately 2:1. In the illustrated embodiment, the substrate 110 has an overall size of approximately 11 mm×6 mm×3 mm. Other sizes/ratios are possible in alternative embodiments.

In an exemplary embodiment, the substrate 110 is a printed circuit board. The substrate 110 may have one or more layers. In an exemplary embodiment, the substrate 110 is manufactured from a PCB material, such as a low loss PCB material that exhibits a minimum loss across the design frequency and improved signal fidelity. The PCB material may include polytetrafluoroethylene (PTFE), FR4-grade materials, polyimide materials, and the like.

In an alternative embodiment, the substrate 110 may be manufactured from alternative processes and materials. For example, the substrate 110 may be manufactured from a ceramic material. For example, the substrate 110 may be a ceramic block. In other alternative embodiments, the substrate 110 may be manufactured from a laser direct structuring (LDS) process from an LDS material. For example, the substrate 110 may be an injection molded plastic body having LDS additive material embedded in the injection molded plastic body. The other components of the UWB antenna 100, such as the radiating patch 130, the parasitic elements 150, the antenna ground 170 and the shorting pins 190, may be manufactured by the LDS process.

In an exemplary embodiment, the substrate 110 includes a plurality of openings or vias 124 therethrough between the upper surface 112 and the lower surface 114. The vias 124 receive the shorting pins 190. For example, the vias 124 may be plated through holes forming the shorting pins 190.

The radiating patch 130 is provided on the upper surface 112. In an exemplary embodiment, the radiating patch 130 is linearly polarized. The radiating patch 130 may be designed to have other polarization in alternative embodiments.

In an exemplary embodiment, the radiating patch 130 is shorted to the antenna ground 170 through the shorting pins 190. Shorting the radiating patch 130 is used to reduce or miniaturize the size of the radiating element. In an exemplary embodiment, the radiating patch 130 is shorted to the antenna ground 170 using a plurality of the shorting pins 190, such as four of the shorting pins 190. In the illustrated embodiment, the shorting pins 190 have a diameter of approximately 0.6 mm. Other diameters are possible in alternative embodiments. Greater or fewer shorting pins 190 may be used in alternative embodiments. For example, a single, elongated shorting element may be provided rather than the four shorting pins 190 in a row. In an alternative embodiment, one or more shorting traces may be provided along the first end 116 between the radiating patch 130 and the antenna ground 170. In other alternative embodiments, a stamped and formed shorting element may be provided between the radiating patch 130 in the antenna ground 170, such as along the first end 116 or passing through an opening through the substrate 110.

In an exemplary embodiment, the radiating patch 130 is a printed circuit printed on the upper surface 112 of the substrate 110. The radiating patch 130 may be manufactured by other processes in alternative embodiments. For example, the radiating patch 130 may be a stamped and formed radiating patch. The radiating patch 130 may be a film or foil applied to the upper surface 112 of the substrate 110.

In an exemplary embodiment, the radiating patch 130 is planar. In an exemplary embodiment, the radiating patch 130 is rectangular. The radiating patch 130 may have other shapes in alternative embodiments. In the illustrated embodiment, the radiating patch 130 includes a first end 132 and a second end 134. The radiating patch 130 includes a first side 136 and a second side 138 extending between the first and second ends 132, 134. In an exemplary embodiment, the shorting pins 190 are coupled to the radiating patch 130 at the first end 132. Other locations are possible in alternative embodiments.

In an exemplary embodiment, the radiating patch 130 includes an excitation point 140 that acts as a feed for the radiating patch 130. The UWB antenna 100 includes a feed pin 142 coupled to the excitation point 140. The feed pin 142 may be a plated through hole passing through the substrate 110. The feed pin 142 may have a diameter selected to match a target impedance, such as 50 Ohms. In the illustrated embodiment, the feed pin 142 has a diameter of approximately 0.6 mm. Other diameters are possible in alternative embodiments. In the illustrated embodiment, the excitation point 140 is located at the second end 134. For example, the excitation point 140 is located remote from the shorting pins 190. The distance or spacing between the excitation point 140 and the shorting pins 190 may be selected to control the resonance frequency of the UWB antenna 100.

The parasitic elements 150 are provided on the upper surface 112. For example, the parasitic elements 150 may be located proximate to the radiating patch 130. The parasitic elements 150 may be capacitively coupled to the radiating patch 130. The parasitic elements 150 generate extra field with the radiating patch 130 in a wider region. The radiating patch 130 is designed so that it induces significant current due to the strong parasitic coupling to the parasitic elements 150. In an exemplary embodiment, the parasitic elements 150 are coplanar with the radiating patch 130. The parasitic elements 150 may be coupled to the antenna ground 170 through the substrate 110.

In an exemplary embodiment, the parasitic elements 150 is shorted to are provided at the second end 134 of the radiating patch 130. For example, the parasitic elements 150 may be located between the second end 134 of the radiating patch 130 and the second end 118 of the substrate 110. The parasitic elements 150 may substantially fill the space between the second end 134 of the radiating patch 130 and the second end 118 of the substrate 110. In the illustrated embodiment, two of the parasitic elements 150 are provided. Greater or fewer parasitic elements 150 may be provided in alternative embodiments. Other locations are possible in alternative embodiments. For example, one or more parasitic elements 150 may be provided along the side(s) of the radiating patch 130 and/or along the first end 132 of the radiating patch 130.

In an exemplary embodiment, the parasitic elements 150 are printed circuits printed on the upper surface 112 of the substrate 110. The parasitic elements 150 may be manufactured by other processes in alternative embodiments. For example, the parasitic elements 150 may be a stamped and formed elements. The parasitic elements 150 may be films or foils applied to the upper surface 112 of the substrate 110.

In an exemplary embodiment, the parasitic elements 150 are planar. In an exemplary embodiment, the parasitic elements 150 are rectangular. The parasitic elements 150 may have other shapes in alternative embodiments. In the illustrated embodiment, the parasitic elements 150 are separated from each other by a gap 152. The parasitic elements 150 may be separated from the radiating patch 130 by a gap 154. In an exemplary embodiment, the parasitic elements 150 are symmetrical (for example, about the gap 152). In alternative embodiments, the parasitic elements 150 may be asymmetrical.

The antenna ground 170 is provided on the lower surface 114. In an exemplary embodiment, the antenna ground 170 is a printed circuit printed on the lower surface 114 of the substrate 110. The antenna ground 170 may be manufactured by other processes in alternative embodiments. For example, the antenna ground 170 may be a stamped and formed ground element. The antenna ground 170 may be a film or foil applied to the lower surface 114 of the substrate 110.

In an exemplary embodiment, the antenna ground 170 is shorted to the radiating patch 130 through the shorting pins 190 to reduce or miniaturize the size of the radiating element. In an exemplary embodiment, a plurality of the shorting pins 190 are provided between the antenna ground 170 and the radiating patch 130.

In an exemplary embodiment, the antenna ground 170 is planar. In an exemplary embodiment, the antenna ground 170 generally rectangular with a main portion 180, which is configured to be generally aligned with the radiating patch 130. Optionally, at least a portion of the main portion 180 may be aligned with one or more of the parasitic elements 150. In an exemplary embodiment, the antenna ground 170 includes a slot 183 formed therein flanked on opposite sides by legs 182, 184. The legs 182, 184 may be aligned with the parasitic elements 150. Optionally, portions of the legs 182 184 may be aligned with the radiating patch 130.

In the illustrated embodiment, the antenna ground 170 includes a first end 172 and a second end 174. The antenna ground 170 includes a first side 176 and a second side 178 extending between the first and second ends 172, 174. The legs 182, 184 are provided at the sides 176, 178, respectively. The slot 183 may be open at the first end 172. Other locations for the slot 183 and the legs 182, 184 are possible in alternative embodiments.

In an exemplary embodiment, a feed pad 186 is located in the slot 183 between the legs 182, 184. The feed pin 142 is coupled to the feed pad 186. The feed pad 186 is configured to be coupled to the host circuit board 20 and/or the feed line 104 (shown in FIG. 1). In an exemplary embodiment, the shorting pins 190 are coupled to the antenna ground 170 at the first end 132. Other locations are possible in alternative embodiments.

In an exemplary embodiment, one or more solder pads 188 are provided to couple the UWB antenna 100 to the host circuit board 20. The solder pads 188 are configured to be coupled to the antenna ground 170. For example, the solder pads 188 are configured to be soldered to a host circuit board 20. The solder pads 188 are used to mechanically and electrically couple the antenna ground 170 to the host circuit board 20.

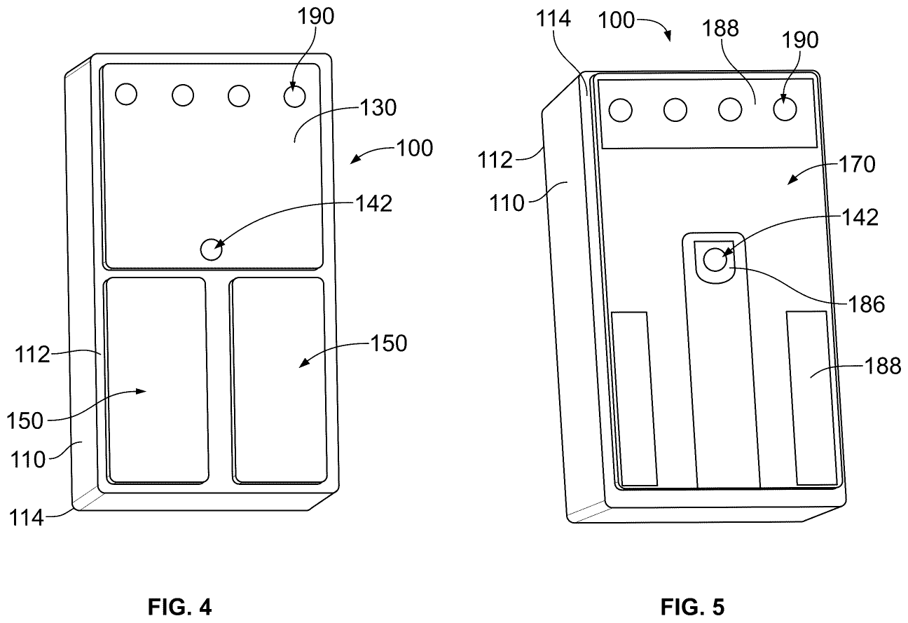

FIG. 4 is a top view of the UWB antenna 100 in accordance with an exemplary embodiment. FIG. 5 is a bottom view of the UWB antenna 100 in accordance with an exemplary embodiment. The radiating patch 130 and the parasitic elements 150 are provided at the upper surface 112 of the substrate 110. The antenna ground 170 and solder pads 188 are provided at the lower surface 114. The shorting pins 190 extend between the radiating patch 130 and the antenna ground 170, such as through the substrate 110. The feed pin 142 extends between the radiating patch 130 and the feed pad 186, such as through the substrate 110.

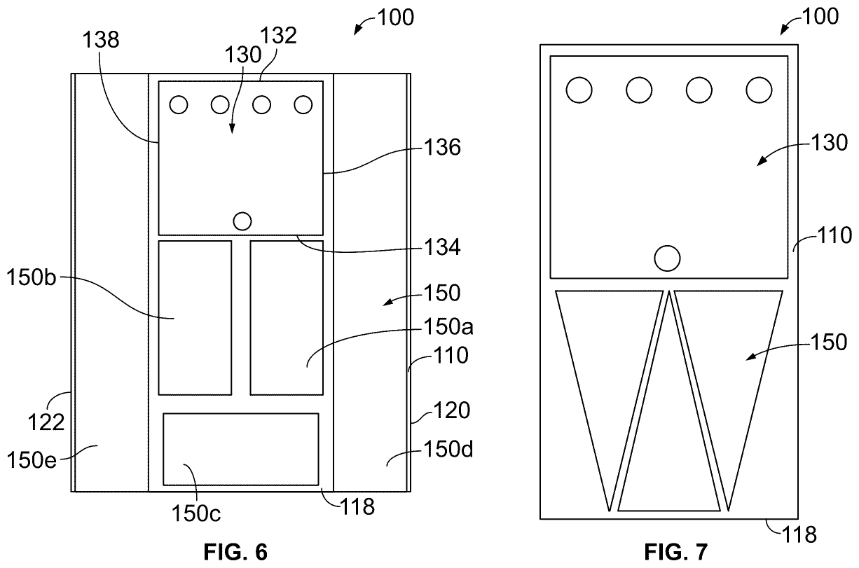

FIG. 6 is a top view of the UWB antenna 100 in accordance with an exemplary embodiment. FIG. 6 shows the UWB antenna 100 having a different arrangement of the parasitic elements 150 compared to the embodiment shown in FIGS. 3-4. In the illustrated embodiment, the parasitic elements 150 are rectangular. Other shapes are possible in alternative embodiments.

In the illustrated embodiment, the UWB antenna 100 includes five parasitic elements 150 including three central parasitic elements 150a, 150b, 150c and two outer parasitic elements 150d, 150e. The outer parasitic elements 150d, 150e may be located between the sides 136, 138 of the radiating patch 130 and the first and second sides 120, 122 of the substrate 110. The outer parasitic elements 150d, 150e may substantially fill the space between the sides 136, 138 of the radiating patch 130 and the first and second sides 120, 122 of the substrate 110. The outer parasitic elements 150d, 150e may extend generally the length of the substrate 110 between the first end 132 and the second end 134. For example, the outer parasitic elements 150d, 150e may be located between the central outer parasitic elements 150a, 150b, 150c and the first and second sides 120, 122. In the illustrated embodiment, the first and second central parasitic elements 150a 150b are located between the third central outer parasitic elements 150c and the radiating patch 130. For example, the third central outer parasitic elements 150c is located between the first and second central parasitic elements 150a 150b and the second end 118 of the substrate 110.

FIG. 7 is a top view of the UWB antenna 100 in accordance with an exemplary embodiment. FIG. 7 shows the UWB antenna 100 having a different arrangement of the parasitic elements 150 compared to the embodiment shown in FIGS. 3-4 or the embodiment shown in FIG. 6. In the illustrated embodiment, the parasitic elements 150 are non-rectangular. For example, the parasitic elements 150 may be triangular shaped. In the illustrated embodiment, the UWB antenna 100 includes three parasitic elements 150 between the radiating patch 130 and the second end 118 of the substrate 110. Other shapes and positions are possible in alternative embodiments.

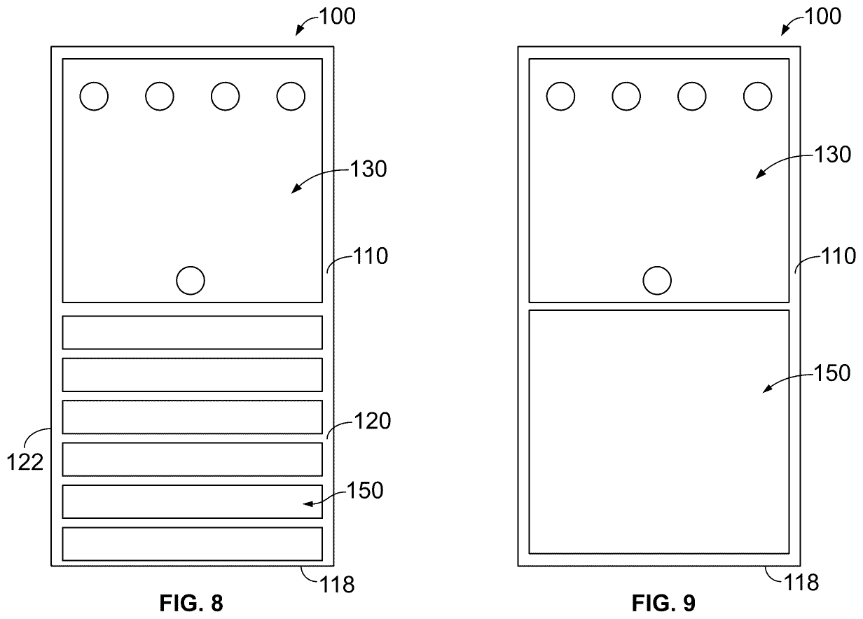

FIG. 8 is a top view of the UWB antenna 100 in accordance with an exemplary embodiment. FIG. 8 shows the UWB antenna 100 having a different arrangement of the parasitic elements 150 compared to the embodiments shown in FIGS. 3-7. In the illustrated embodiment, the parasitic elements 150 are rectangular and arranged side-to-side between the first and second sides 120, 122 of the substrate 110. In the illustrated embodiment, the UWB antenna 100 includes five parasitic elements 150 between the radiating patch 130 and the second end 118 of the substrate 110. Other shapes and positions are possible in alternative embodiments.

FIG. 9 is a top view of the UWB antenna 100 in accordance with an exemplary embodiment. FIG. 9 shows the UWB antenna 100 having a different arrangement of the parasitic element 150 compared to the embodiments shown in FIGS. 3-8. In the illustrated embodiment, a single parasitic element 150 is provided. The parasitic element 150 is rectangular and arranged between the radiating patch 130 and the second end 118 of the substrate 110. The parasitic element 150 may be sized similar to the radiating patch 130. However, the parasitic element 150 may be larger than the radiating patch 130 or smaller than the radiating patch 130 in alternative embodiments. Other shapes and positions are possible in alternative embodiments.

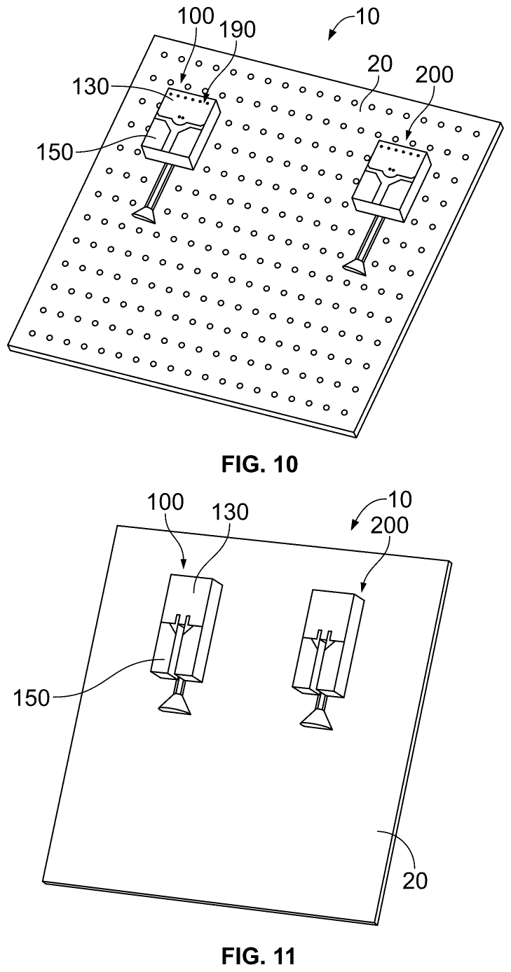

FIG. 10 illustrates the UWB antenna assembly 10 showing the first and second UWB antennas 100, 200 in accordance with an exemplary embodiment mounted to the host circuit board 20. In an exemplary embodiment, the UWB antennas 100, 200 include ceramic-based substrates rather than PCB-based substrates. The radiating patch 130 is sized and shaped differently than the embodiment shown in FIG. 1. The parasitic elements 150 are sized and shaped differently than the embodiment shown in FIG. 1. A different number of shorting pins 190 are provided than the embodiment shown in FIG. 1.

FIG. 11 illustrates the UWB antenna assembly 10 showing the first and second UWB antennas 100, 200 in accordance with an exemplary embodiment mounted to the host circuit board 20. In an exemplary embodiment, the UWB antennas 100, 200 include LDS-based substrates rather than PCB-based substrates. The radiating patch 130 is sized and shaped differently than the embodiment shown in FIG. 1. The parasitic elements 150 are sized and shaped differently than the embodiment shown in FIG. 1.

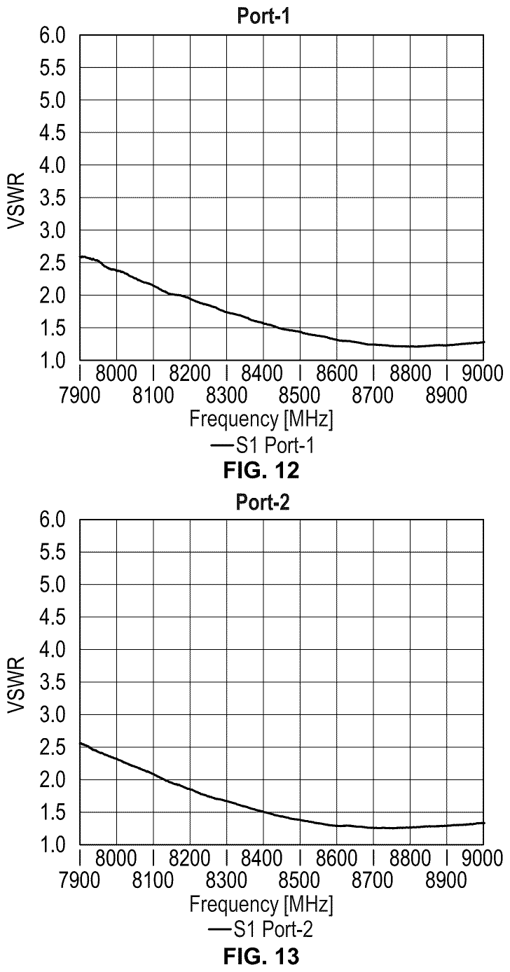

FIGS. 12-25 provide measured results for the UWB antennas 100, 200 in accordance with the embodiment shown in FIG. 1. In an exemplary embodiment, the UWB antennas 100, 200 are designed to have a wide beam angle greater than 120°. For example, the UWB antennas 100, 200 have a wide beam angle greater than 120° in an electric field (E-plane) and the UWB antenna has a wide beam angle greater than 120° in a magnetic field (H-plane). In an exemplary embodiment, the UWB antennas 100, 200 are designed to cover the UWB channel 9 frequency band. In an exemplary embodiment, the UWB antennas 100, 200 are designed to cover the UWB channel 10 frequency band. In an exemplary embodiment, the UWB antennas 100, 200 are operable at a frequency range of between 7987.2-8985.6 MHz. The UWB antennas 100, 200 may be designed to cover other frequency bands in alternative embodiments. In an exemplary embodiment, the UWB antennas 100, 200 have a fidelity factor of greater than 0.95. In an exemplary embodiment, the UWB antennas 100, 200 have a VSWR less than 3:1. In various embodiments, the UWB antennas 100, 200 have a VSWR less than 2:1. In an exemplary embodiment, the UWB antennas 100, 200 have isolation of greater than 20 dB. In an exemplary embodiment, the UWB antennas 100, 200 have an impedance of 50 Ohms. In an exemplary embodiment, the UWB antennas 100, 200 have a total efficiency of greater than 70%. In an exemplary embodiment, the UWB antennas 100, 200 have a front-to-back ratio of greater than 20 dB. In an exemplary embodiment, the UWB antennas 100, 200 may have a height of less than 4 mm. In an exemplary embodiment, the UWB antennas 100, 200 may have a 3-dB beamwidth (azimuth) of between 120°-160°. In an exemplary embodiment, the UWB antennas 100, 200 may have a 3-dB beamwidth (elevation) of between 120°-160°. In an exemplary embodiment, the UWB antennas 100, 200 may have a pulse delay of less than 0.20 ns. In various embodiments, the UWB antennas 100, 200 may have a pulse delay of less than 0.17 ns.

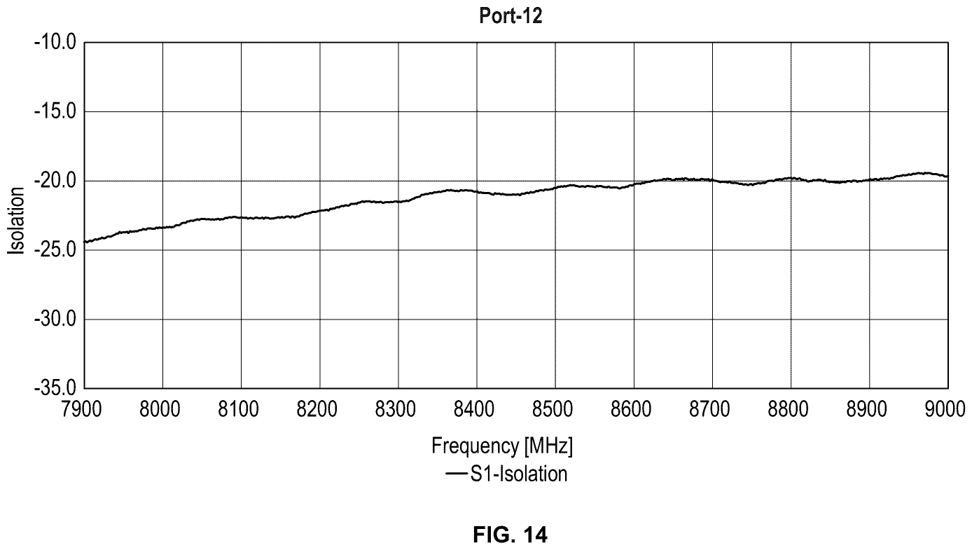

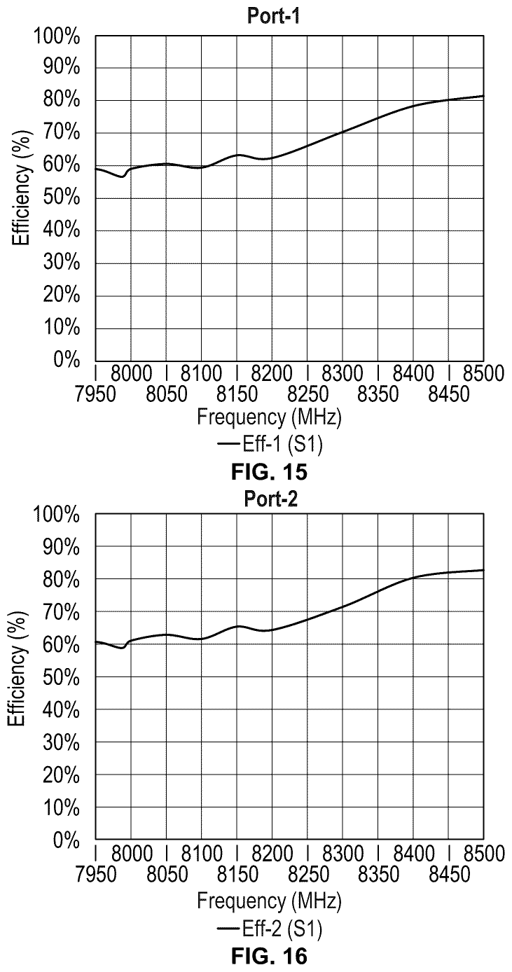

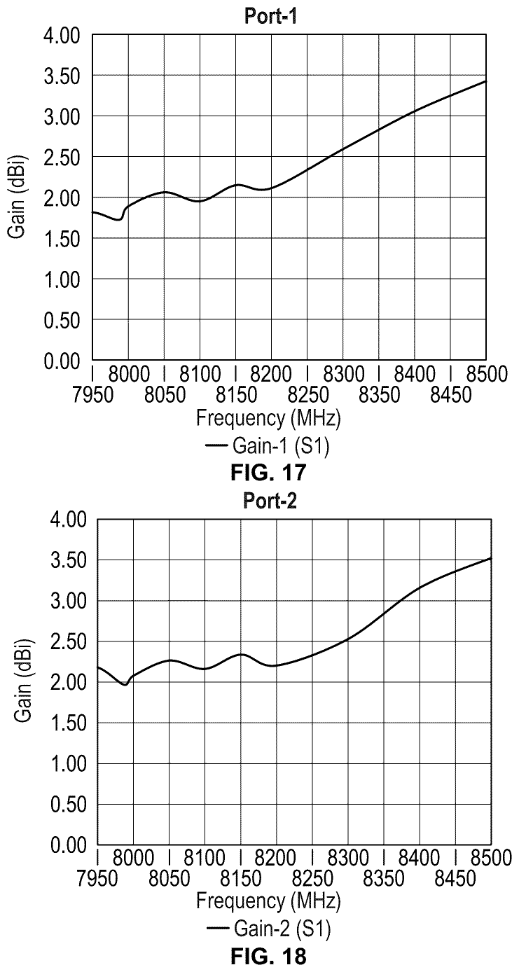

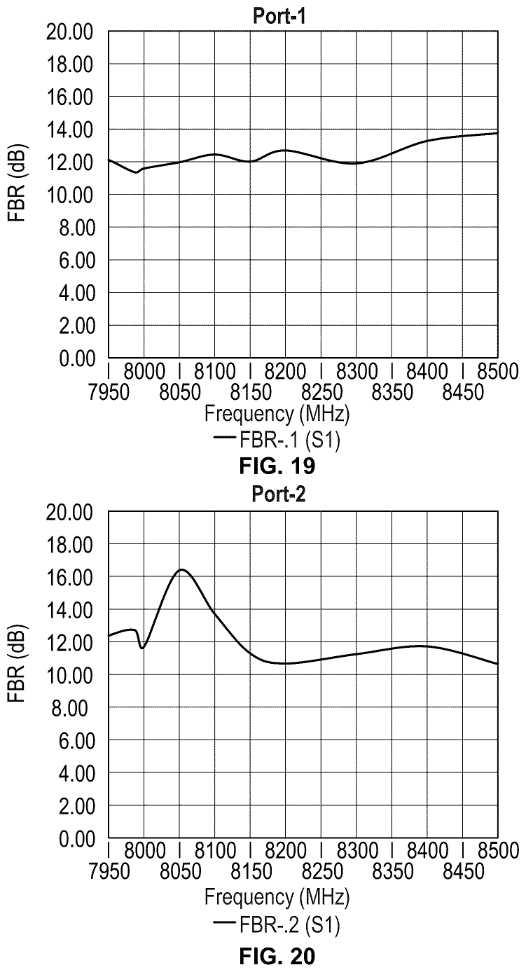

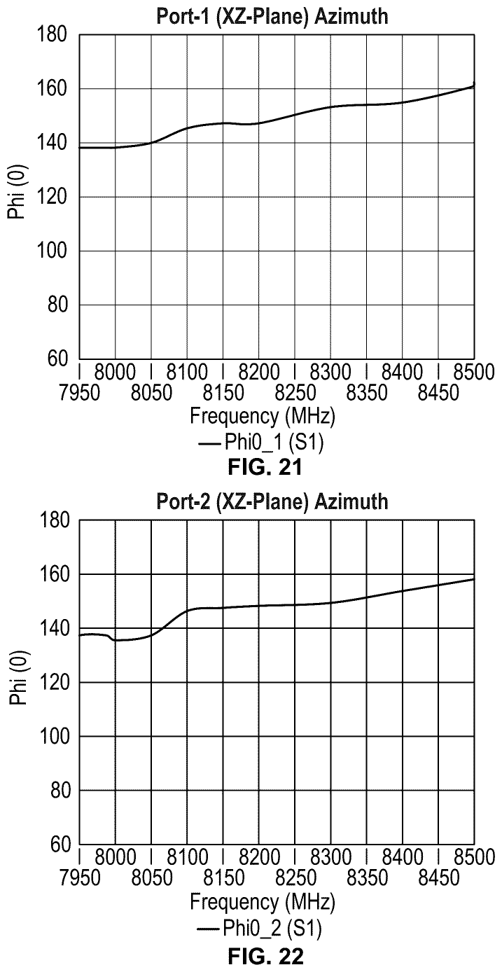

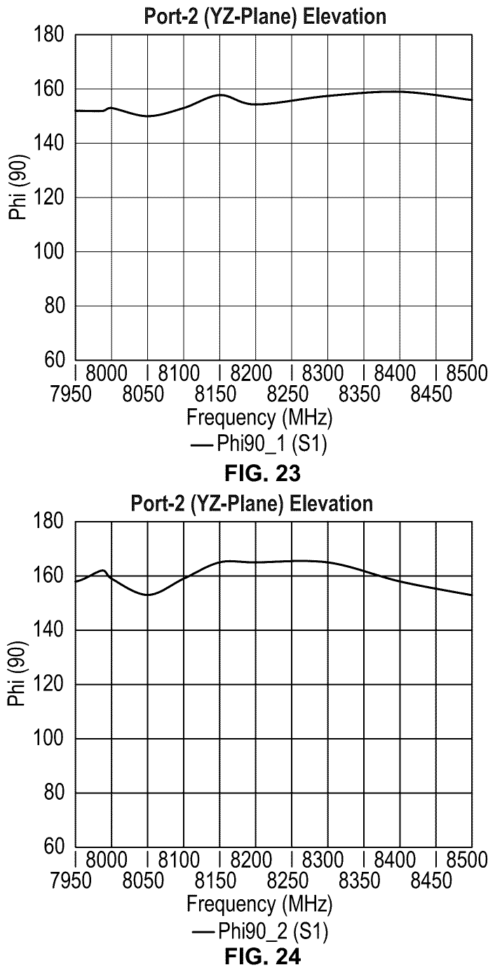

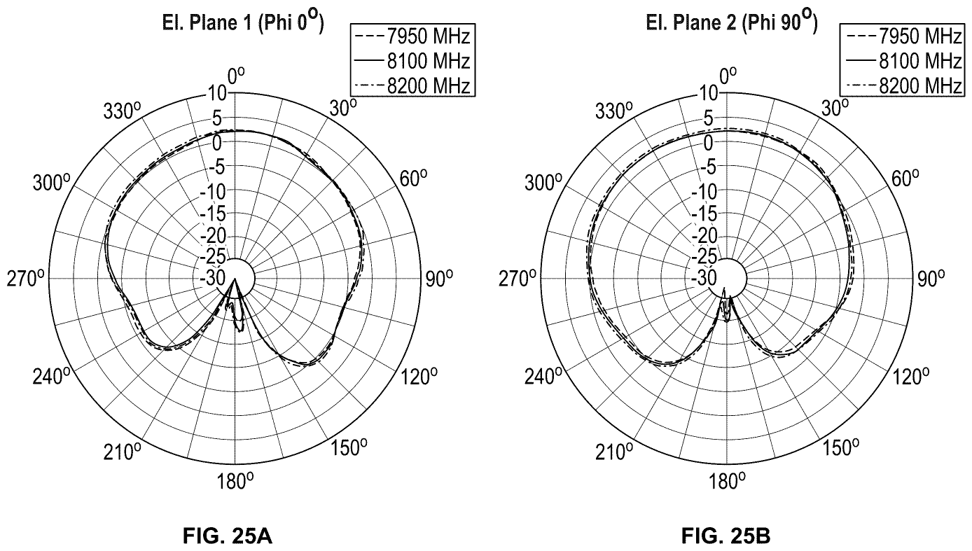

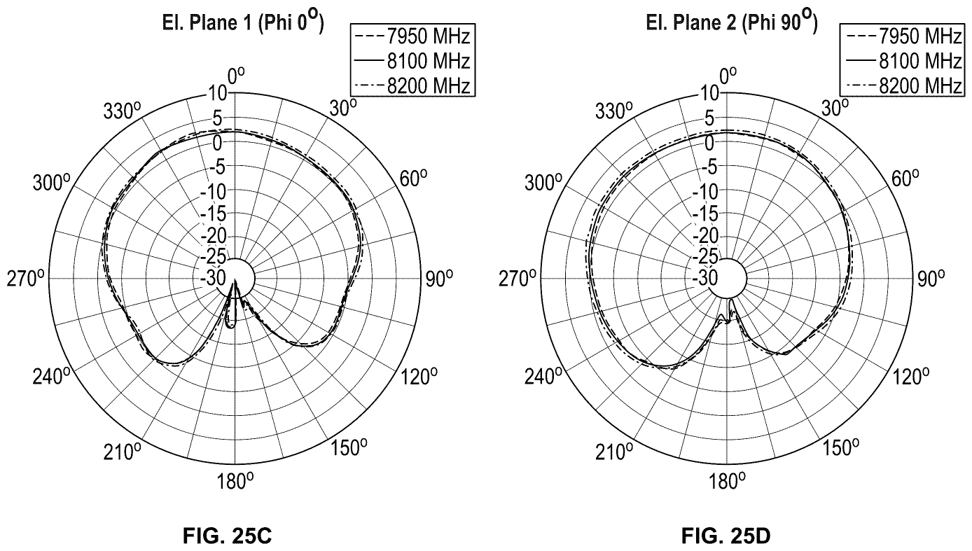

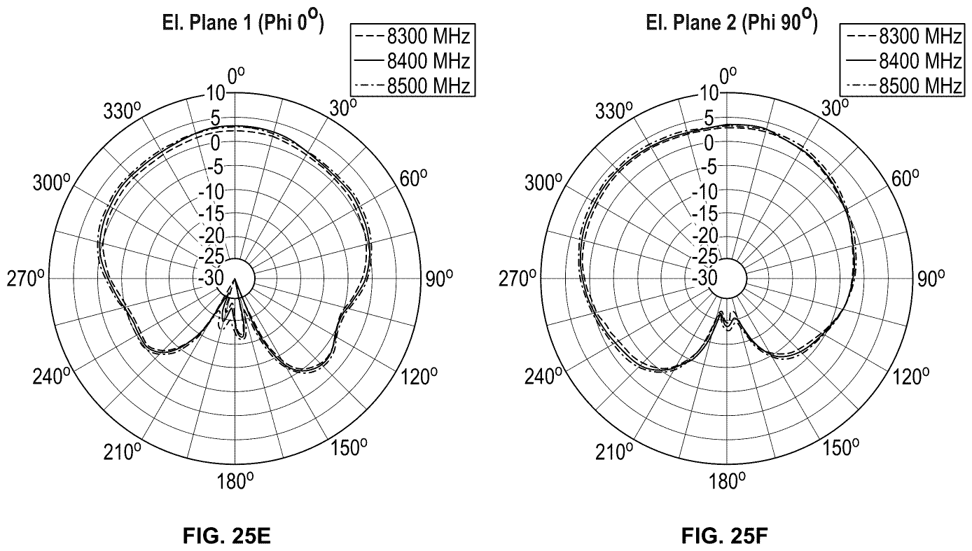

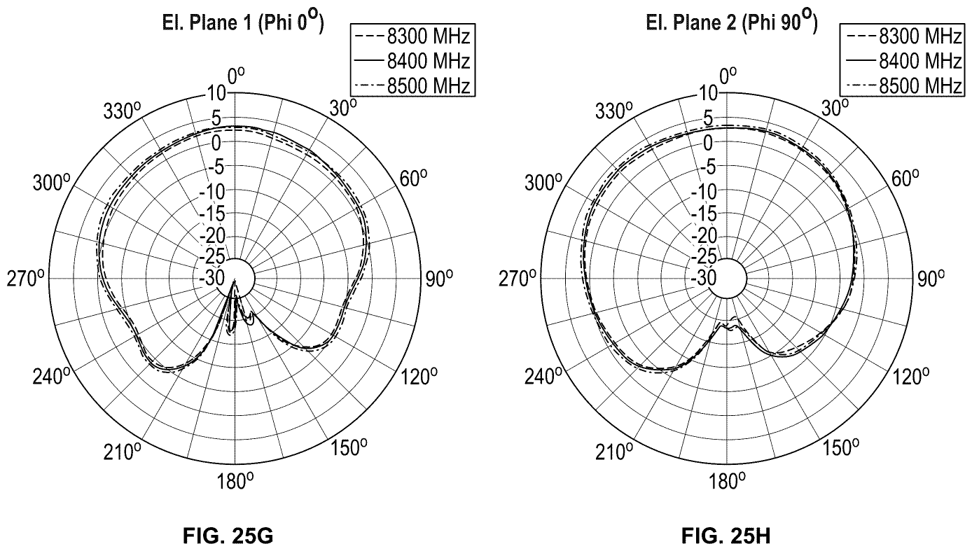

FIGS. 12-13 show VSWR results for the UWB antennas 100, 200, respectively, in the UWB channel 9 frequency band. FIG. 14 shows isolation between the UWB antennas 100, 200 associated with the first and second ports for the UWB antenna assembly 10. FIGS. 15-16 show antenna efficiency results for the UWB antennas 100, 200, respectively, in the UWB channel 9 frequency band. FIGS. 17-18 show antenna gain results for the UWB antennas 100, 200, respectively, in the UWB channel 9 frequency band. FIGS. 19-20 show front-to-back ratio results for the UWB antennas 100, 200, respectively, in the UWB channel 9 frequency band. FIGS. 21-22 show 3 dB beamwidth phi 0 (XZ Plane-Azimuth) results for the UWB antennas 100, 200, respectively, in the UWB channel 9 frequency band. FIGS. 23-24 show 3 dB beamwidth phi 90 (YZ Plane-Elevation) results for the UWB antennas 100, 200, respectively, in the UWB channel 9 frequency band. FIGS. 25a-25h show radiation patterns for the UWB antenna 100 at various frequencies. The analysis results shown in FIGS. 12-25 are provided for purposes of illustration and not for purposes of limitation. Alternative embodiments of UWB antennas may be configured differently and have different operational or performance parameters than what is shown in FIGS. 12-25.

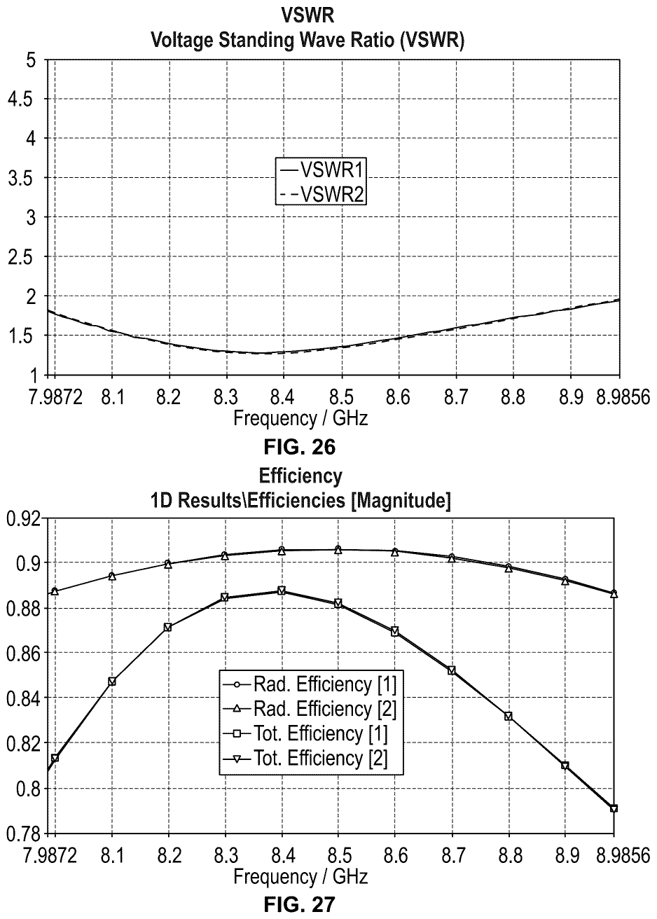

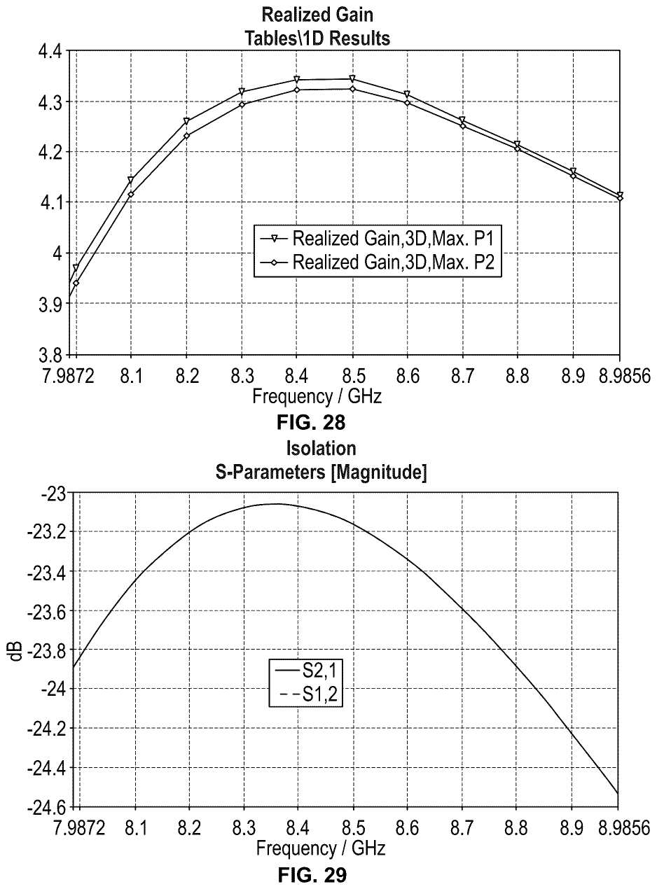

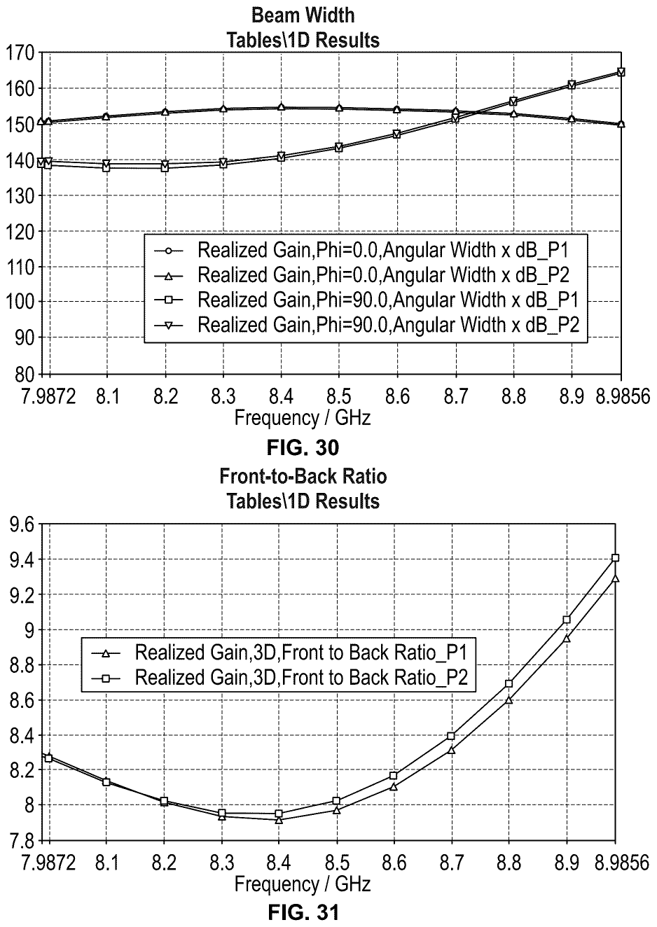

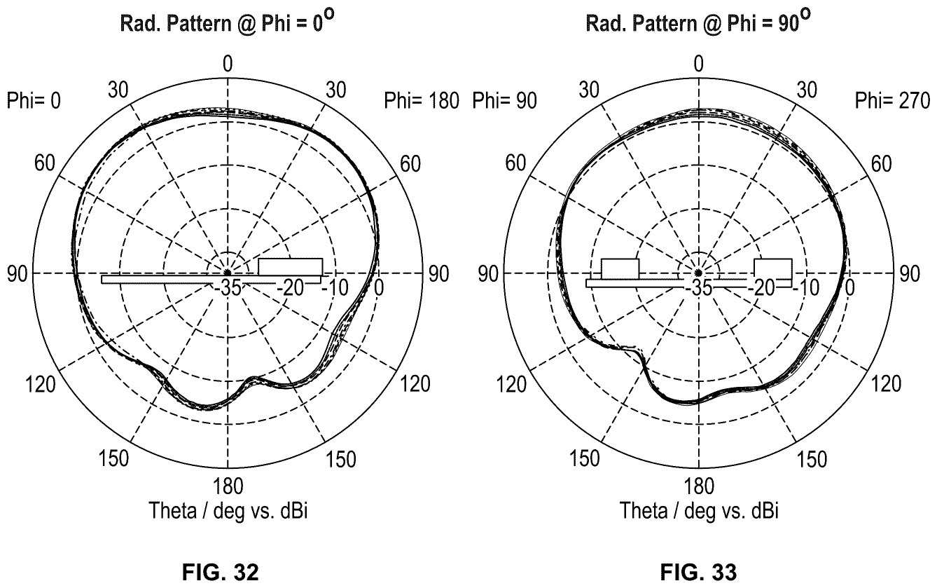

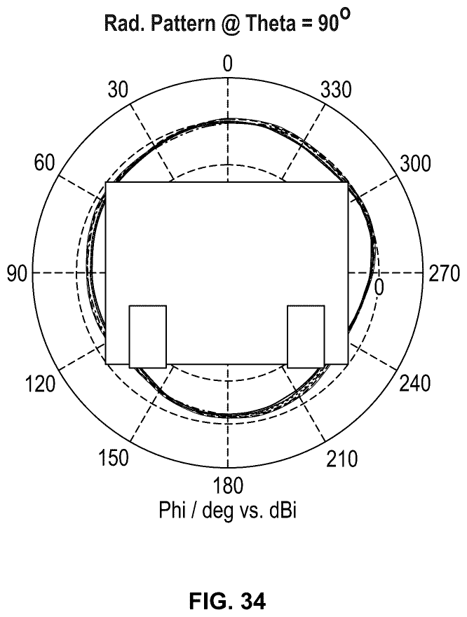

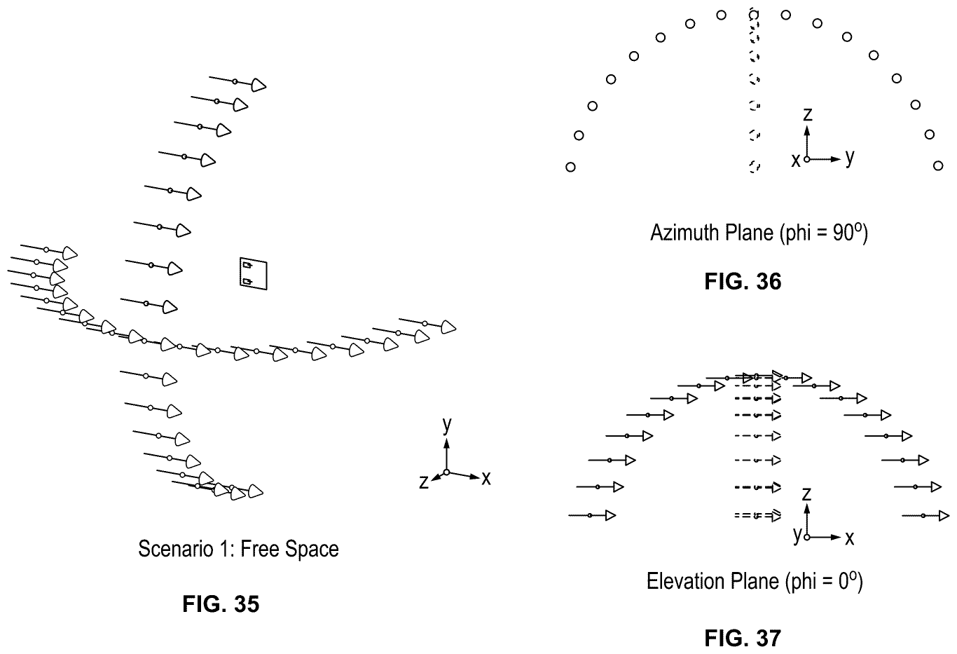

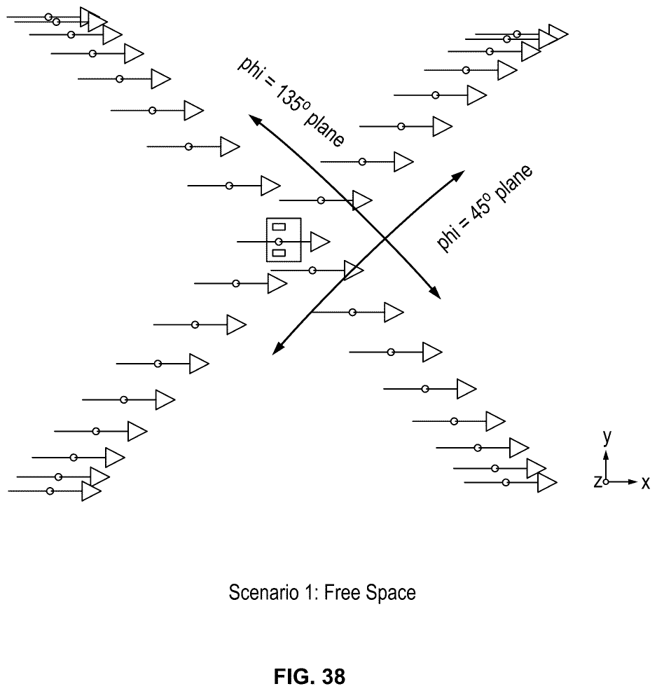

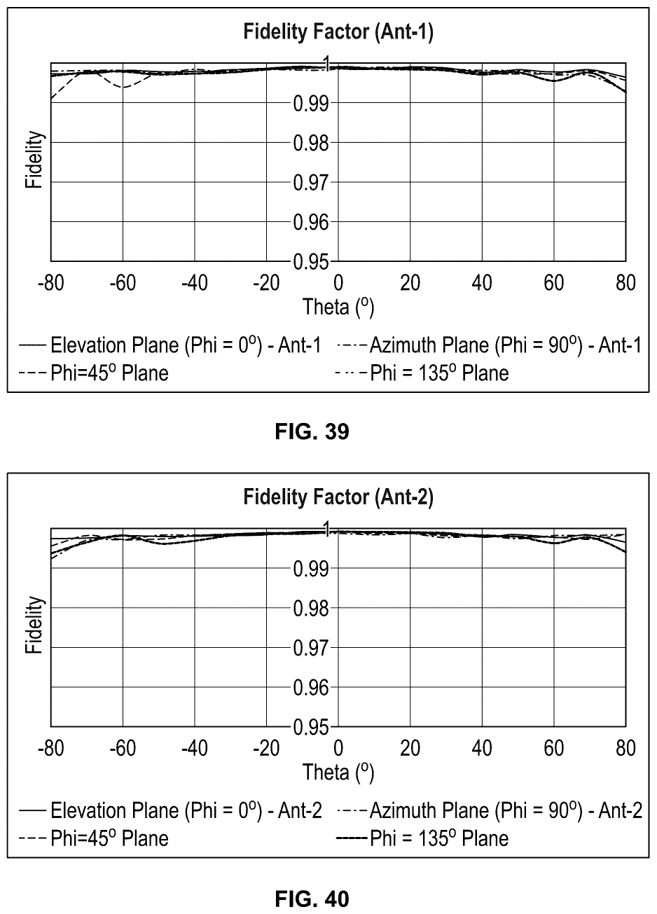

FIGS. 26-40 provide measured results for the UWB antennas 100, 200 in accordance with the embodiment shown in FIG. 1. FIG. 26 shows VSWR results for the UWB antennas 100, 200. FIG. 27 shows efficiency results for the UWB antennas 100, 200. FIG. 28 shows realized gain results for the UWB antennas 100, 200. FIG. 29 shows isolation results for the UWB antennas 100, 200. FIG. 30 shows beam width results for the UWB antennas 100, 200. FIG. 31 shows front-to-back ratio results for the UWB antennas 100, 200. FIG. 32 shows radiation patterns @ Phi=0° for the UWB antennas 100, 200. FIG. 33 shows radiation patterns @ Phi=90° for the UWB antennas 100, 200. FIG. 34 shows radiation patterns @ Theta=90° for the UWB antennas 100, 200. FIG. 35 shows fidelity factor for the UWB antennas 100, 200 in free space. FIG. 36 shows fidelity factor for the UWB antennas 100, 200 @ Phi=90° (Azimuth plane) for the UWB antennas 100, 200. FIG. 37 shows fidelity factor for the UWB antennas 100, 200 @ Phi=0° (Elevation plane) for the UWB antennas 100, 200. FIG. 38 shows fidelity factor (Phi=45° and Phi=135°) for the UWB antennas 100, 200 in free space. FIG. 39 shows fidelity factor for the first UWB antenna 100 on UWB channels 9 and 10 in free space. FIG. 40 shows fidelity factor for the second UWB antenna 200 on UWB channels 9 and 10 in free space. The analysis results shown in FIGS. 26-40 are provided for purposes of illustration and not for purposes of limitation. Alternative embodiments of UWB antennas may be configured differently and have different operational or performance parameters than what is shown in FIGS. 26-40.

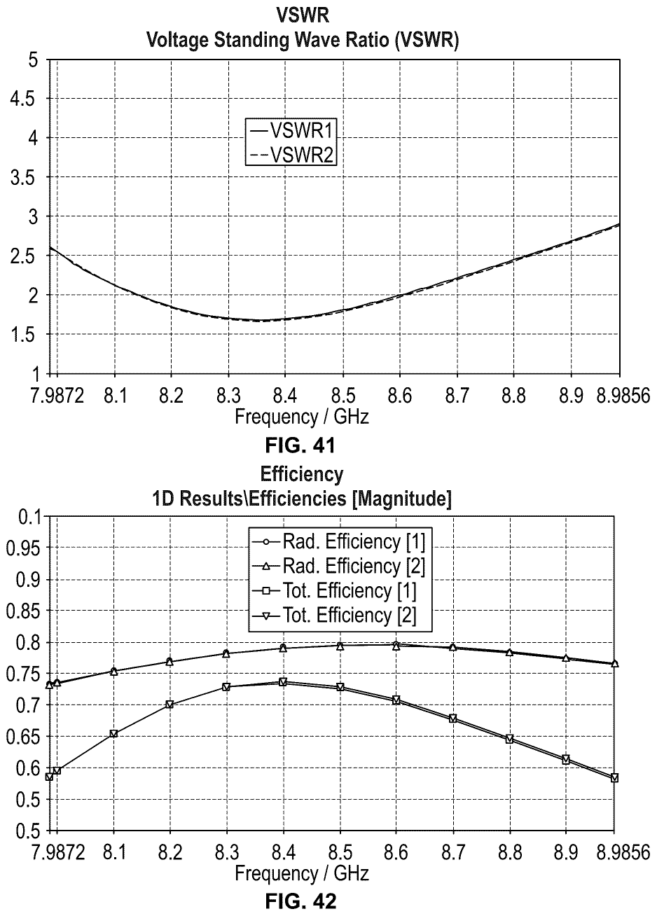

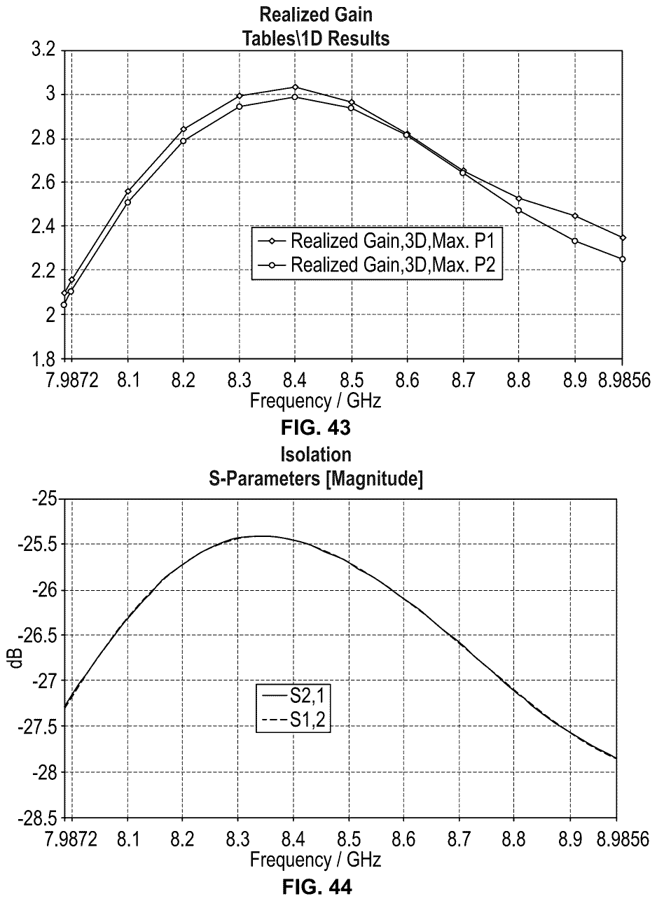

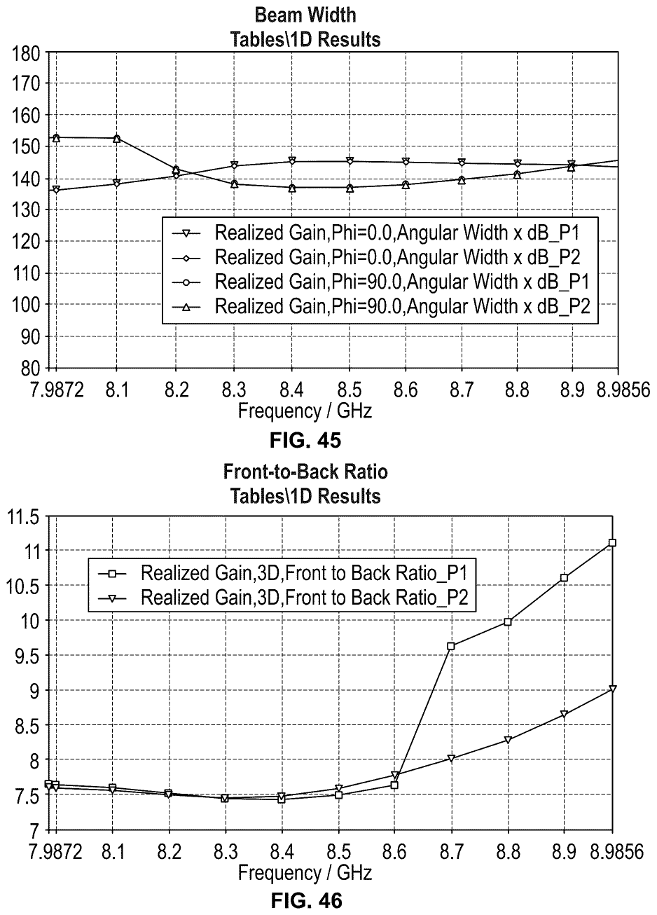

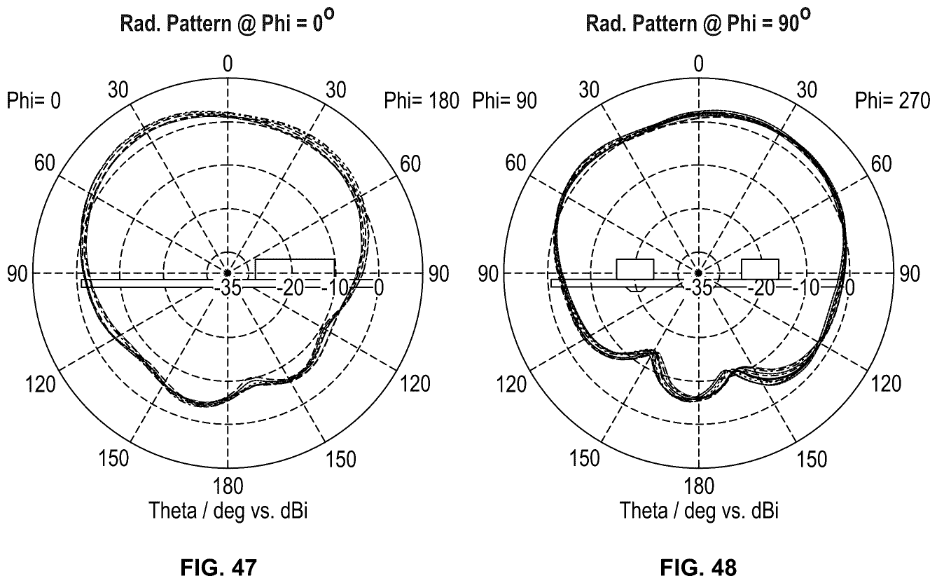

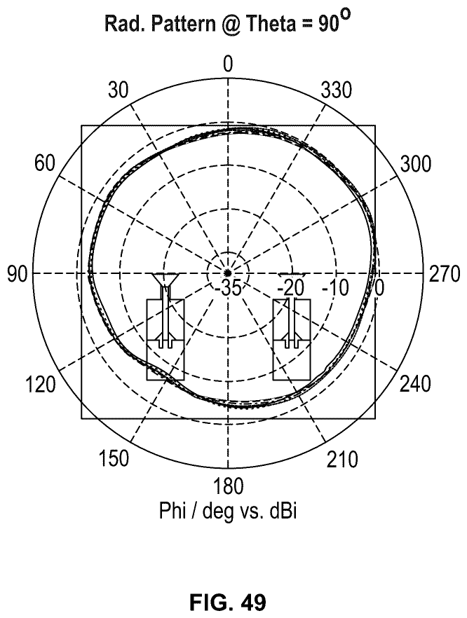

FIGS. 41-49 provide measured results for the UWB antennas 100, 200 in accordance with the embodiment shown in FIG. 10. FIG. 41 shows VSWR results for the UWB antennas 100, 200. FIG. 42 shows efficiency results for the UWB antennas 100, 200. FIG. 43 shows realized gain results for the UWB antennas 100, 200. FIG. 44 shows isolation results for the UWB antennas 100, 200. FIG. 45 shows beam width results for the UWB antennas 100, 200. FIG. 46 shows front-to-back ratio results for the UWB antennas 100, 200. FIG. 47 shows radiation patterns @ Phi=0° for the UWB antennas 100, 200. FIG. 48 shows radiation patterns @ Phi=90° for the UWB antennas 100, 200. FIG. 49 shows radiation patterns @ Theta=90° for the UWB antennas 100, 200.

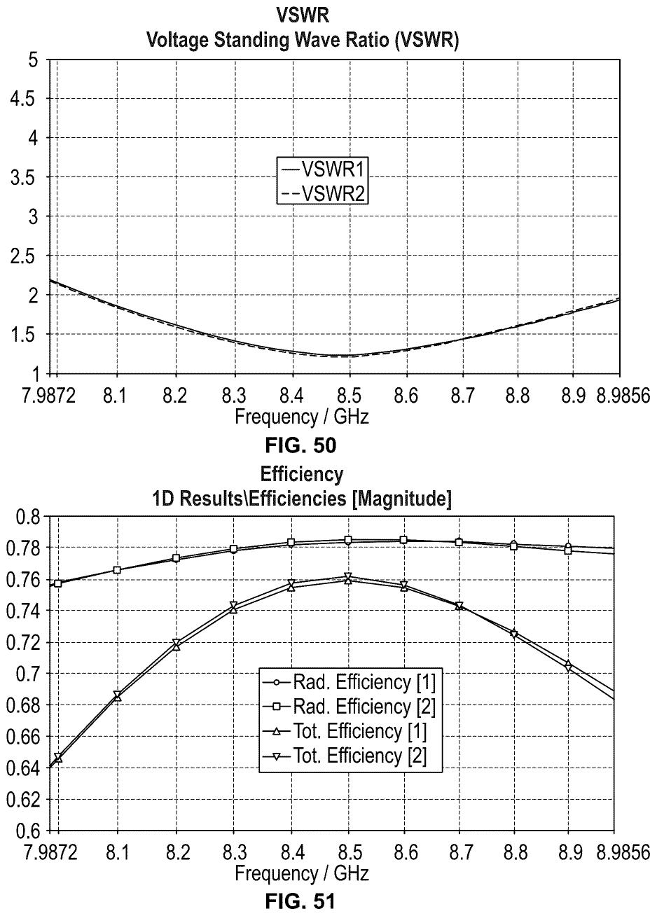

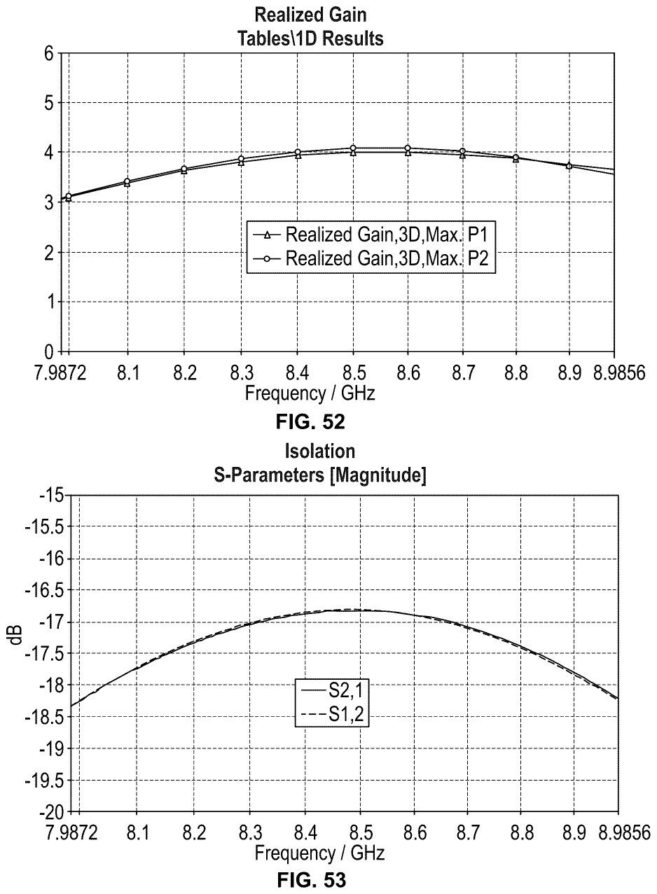

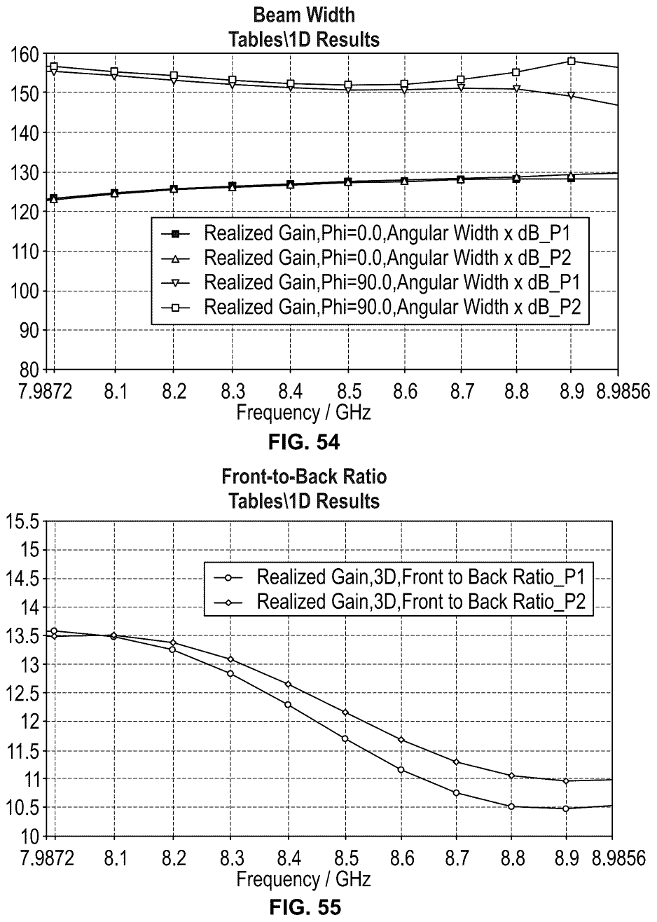

FIGS. 50-55 provide measured results for the UWB antennas 100, 200 in accordance with the embodiment shown in FIG. 11. FIG. 50 shows VSWR results for the UWB antennas 100, 200. FIG. 51 shows efficiency results for the UWB antennas 100, 200. FIG. 52 shows realized gain results for the UWB antennas 100, 200. FIG. 53 shows isolation results for the UWB antennas 100, 200. FIG. 54 shows beam width results for the UWB antennas 100, 200. FIG. 55 shows front-to-back ratio results for the UWB antennas 100, 200.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. An ultra-wideband (UWB) antenna comprising:
a substrate having a first surface and a second surface;
a radiating patch at the first surface;
parasitic elements at the first surface adjacent the radiating patch;
an antenna ground at the second surface; and
shorting pins between the radiating patch and the antenna ground;
wherein the UWB antenna has a wide beam angle greater than 120°; and
wherein the UWB antenna covers the UWB channel 9 frequency band.

2. The UWB antenna of claim 1, wherein the UWB antenna has a fidelity factor of greater than 0.95.

3. The UWB antenna of claim 1, wherein the UWB antenna has a wide beam angle greater than 120° in an electric field in an E-plane and the UWB antenna has a wide beam angle greater than 120° in a magnetic field in an H-plane.

4. The UWB antenna of claim 1, wherein the substrate is a printed circuit board manufactured from a low loss material.

5. The UWB antenna of claim 1, wherein the substrate is a laser direct structured (LDS) substrate including an injection molded plastic body having LDS additive material embedded in the injection molded plastic body.

6. The UWB antenna of claim 1, wherein the substrate is a ceramic substrate.

7. The UWB antenna of claim 1, wherein the radiating patch includes an excitation point and a feed pin coupled to the excitation point.

8. The UWB antenna of claim 7, wherein the radiating patch includes a first end and a second end, the shorting pins being coupled to the radiating patch at the first end, the feed pin coupled to the excitation point at the second end.

9. The UWB antenna of claim 1, wherein the radiating patch includes a first end and a second end, the shorting pins being coupled to the radiating patch at the first end, the parasitic elements located at the second end.

10. The UWB antenna of claim 1, wherein the radiating patch is linearly polarized.

11. The UWB antenna of claim 1, wherein the UWB antenna covers the UWB channel 10 frequency band.

12. The UWB antenna of claim 1, wherein the parasitic elements are coplanar with the radiating patch.

13. The UWB antenna of claim 1, wherein the parasitic elements are symmetrical.

14. The UWB antenna of claim 1, wherein parasitic elements are separated from the radiating patch by a gap, the parasitic elements being separated from each other by a gap.

15. The UWB antenna of claim 1, wherein the radiating patch is rectangular, the parasitic elements being rectangular.

16. The UWB antenna of claim 1, wherein shorting pins are plated vias through the substrate.

17. The UWB antenna of claim 1, wherein the substrate has a length between first and second ends, a width between first and second sides, and a height between the first and second surfaces, the substrate having a length-to-width ratio of approximately 2:1 and a width-to-height ratio of approximately 2:1.

18. The UWB antenna of claim 1, further comprising solder pads at the antenna ground configured to be soldered to a host circuit board.

19. An ultra-wideband (UWB) antenna assembly comprising:
a host circuit board;
a first UWB antenna mounted to the host circuit board, the first UWB antenna including a first substrate having a first surface and a second surface, a first radiating patch at the first surface of the first substrate, first parasitic elements at the first surface of the first substrate adjacent the first radiating patch, a first antenna ground at the second surface of the first substrate, and first shorting pins between the radiating patch and the antenna ground, wherein the first UWB antenna has a wide beam angle greater than 120° and wherein the first UWB antenna covers the UWB channel 9 frequency band; and
a second UWB antenna mounted to the host circuit board, the second UWB antenna including a second substrate having a first surface and a second surface, a second radiating patch at the first surface of the second substrate, second parasitic elements at the first surface of the second substrate adjacent the second radiating patch, a second antenna ground at the second surface of the second substrate, and second shorting pins between the radiating patch and the antenna ground, wherein the second UWB antenna has a wide beam angle greater than 120° and wherein the second UWB antenna covers the UWB channel 9 frequency band.

20. The UWB antenna assembly of claim 19, wherein the UWB antenna assembly is a 2×2 MIMO antenna assembly.

21. The UWB antenna assembly of claim 19, further comprising a first coaxial feed port operably coupled to the first UWB antenna and a second coaxial feed port operably coupled to the second UWB antenna.
